(19) United States
(12) Patent Application Publication
(10) Pub. No.: US 2025/0232373 A1
(43) Pub. Date: Jul. 17, 2025

(54) COMPUTER-IMPLEMENTED METHODS AND COMPUTER SYSTEMS FOR SECURE EXCHANGE OF CURRENCY

(71) Applicant: AZKR Research Association, Zug (CH)

(72) Inventor: Vincenzo Iovino, Nocera Superiore (IT)

(73) Assignee: AZKR Research Association, Zug (CH)

(21) Appl. No.: 19/012,979

(22) Filed: Jan. 8, 2025

Related U.S. Application Data
(60) Provisional application No. 63/620,905, filed on Jan. 15, 2024.

(51) Int. Cl. G06Q 40/04; G06Q 20/06

(52) U.S. Cl. CPC G06Q 40/04; G06Q 20/06

(57) ABSTRACT

Embodiments of the present invention provide a computer-implemented method for secure exchange of currency. The computer-implemented method includes transmitting a receiver digital certificate to a sender device. In some circumstances, the sender device is configured to compute the receiver digital certificate using publicly available information. Furthermore, the computer-implemented method includes receiving a financial message indicative of transfer of a predetermined amount of a currency from a sender financial account to a receiver financial account. The computer-implemented method further includes facilitating the transfer of the predetermined amount of the currency to the receiver financial account. Furthermore, the computer-implemented method includes receiving a request for withdrawal of all or a part of the predetermined amount of the currency, from a receiver device. The computer-implemented method also includes facilitating the withdrawal of the all or the part of the predetermined amount of the currency from the receiver financial account.

### CROSS-REFERENCE TO RELATED APPLICATION

The present application claims priority to U.S. provisional patent Application Ser. No. 63/620,905, filed on Jan. 15, 2024, entitled “Computer-Implemented Methods and Computer System for Secure Exchange of Currency”, the disclosure of which is hereby incorporated by reference, in its entirety.

### TECHNICAL FIELD

The present invention relates generally to electronic financial transactions. More specifically, the present invention relates to secure exchanges of digital and fiat currencies and the maintenance of records of such currency exchanges that are resistant to tampering and repudiation.

### BACKGROUND ART

Online money transfers and currency exchanges are increasingly being accepted as viable and greener alternatives to printed currency bills. Although digitization is often associated with cryptocurrencies such as Bitcoin, Ethereum, Dogecoin, etc., however, even fiat currencies are also being increasingly exchanged through online transfers. Many countries like India and China are leading in the digitization of fiat currency exchanges, and digital transfers are being accepted in almost all forms of trade and commerce. However, with digitization, there is a common hazard of hacking attacks and cyber fraud. Also, information that should rather be confidential, such as name, address, account details, account balance, deposits, withdrawals, etc. has become susceptible to hacking and cloning, thereby increasing the rates of online financial fraud and extortion, etc.

However, providing complete anonymity to users is also not desirable as it enables other social evils such as money laundering, illegal weapons trade, online pornography distribution, and funding of extremist and violent groups. In such a scenario it becomes difficult for law enforcement agencies to maintain order as it becomes almost impossible for them to follow the trail of money being used in illicit activities and reach the source of money. Therefore, there is a need for methods and systems for secure currency exchanges that provide a balance between maintaining the confidentiality of the personal information of users and maintaining the transparency of online currency exchanges so that such currency exchanges are not used for illicit activities.

### OBJECTS OF THE INVENTION

Some of the objects of the invention are as follows:

An object of the present invention is to provide computer-implemented methods and computer systems that enable currency exchanges to be secured using a pair of correlated encryption keys where a financial message indicative of the transfer of an amount of a currency includes identification details of a receiver, the identification details obtained from a digital certificate issued to the receiver.

Another object of the invention is to provide computer-implemented methods and computer systems that enable the receiver to withdraw the entire amount of the transferred currency or a part of the transferred amount using a digital signature generated using a private key assigned to the receiver.

Another object of the invention is to provide computer-implemented methods and computer systems that allow details that are very specific to the currency exchange to be made publicly available without other details, such as the total account balance, of the sender or the receiver to be revealed.

Another object of the invention is to provide computer-implemented methods and computer systems that enable the maintenance of tamper-resistant and non-repudiable records of the exchanges of currency between the senders and the receivers.

It is also an object of the invention that the computer-implemented methods and computer systems apply to both fiat currencies and cryptocurrencies.

### SUMMARY OF THE INVENTION

According to a first aspect of the present invention, there is provided a computer-implemented method for secure exchange of currency. The computer-implemented method includes transmitting, by a controller, a receiver digital certificate issued to a receiver, to a sender device associated with a sender, wherein the receiver digital certificate comprises a receiver public key assigned to the receiver and receiver identification details belonging to the receiver. Furthermore, the computer-implemented method includes receiving, by the controller, a financial message indicative of the transfer of a predetermined amount of a currency, from a sender financial account assigned to the sender, to a receiver financial account assigned to the receiver, wherein the financial message includes the receiver identification details. The computer-implemented method further includes facilitating, by the controller, the transfer of the predetermined amount of the currency from the sender financial account to the receiver financial account. Furthermore, the computer-implemented method includes receiving, by the controller, a request for withdrawal of all or a part of the predetermined amount of the currency, from a receiver device associated with the receiver, the request for withdrawal including a receiver digital signature associated with the receiver. The computer-implemented method also includes facilitating, by the controller, the withdrawal of the all or the part of the predetermined amount of the currency from the receiver financial account.

In one embodiment of the invention, the computer-implemented method further includes publishing transaction information comprising sender identification details associated with the sender, the receiver identification details, and the predetermined amount of currency transferred to the receiver financial account.

In one embodiment of the invention, the currency is selected from a group including fiat currencies and cryptocurrencies.

In one embodiment of the invention, the computer-implemented method further includes hashing transaction information including sender identification details associated with the sender, the receiver identification details, and the predetermined amount of currency transferred to the receiver financial account, to generate a transaction hash. Also, the computer-implemented method includes adding the transaction hash to a distributed ledger.

In one embodiment of the invention, the computer-implemented method further includes adding a time stamp to the transaction information before generating the transaction hash.

According to a second aspect of the present invention, there is provided a computer system for secure exchange of currency. The computer system includes a controller. The controller includes a memory unit comprising machine-readable instructions and a processor operably connected to the memory unit. The processor is configured to execute machine-readable instructions, the machine-readable instructions when executed by the processor, enable the processor to transmit a receiver digital certificate issued to a receiver, to a sender device associated with a sender, wherein the receiver digital certificate comprises a receiver public key assigned to the receiver and receiver identification details belonging to the receiver. The processor is further enabled to receive a financial message indicative of transfer of a predetermined amount of a currency, from a sender financial account assigned to the sender, to a receiver financial account assigned to the receiver, wherein the financial message includes the receiver identification details. Furthermore, the processor is enabled to facilitate the transfer of the predetermined amount of the currency from the sender financial account to the receiver financial account. The processor is further enabled to receive a request for withdrawal of all or a part of the predetermined amount of the currency, from a receiver device associated with the receiver, the request for withdrawal including a receiver digital signature associated with the receiver. The processor is also enabled to facilitate the withdrawal of the all or the part of the predetermined amount of the currency from the receiver financial account.

In one embodiment of the invention, the processor is further enabled to publish transaction information comprising sender identification details associated with the sender, the receiver identification details, and the predetermined amount of currency transferred to the receiver financial account.

In one embodiment of the invention, the currency is selected from a group including fiat currencies and cryptocurrencies.

In one embodiment of the invention, the processor is further enabled to hash transaction information including sender identification details associated with the sender, the receiver identification details, and the predetermined amount of currency transferred to the receiver financial account, to generate a transaction hash. Also, the processor is enabled to add the transaction hash to a distributed ledger.

In one embodiment of the invention, the processor is further enabled to add a time stamp to the transaction information before generating the transaction hash.

In the context of the specification, the term “currency” refers to a standardized form of money used as a medium of exchange of a value of a good or a service, and to facilitate exchange of wealth between individuals, groups, and entities.

In the context of the specification, the term “fiat currency” refers to a form of money that is not backed by a physical commodity, such as gold or silver, but rather by the creditworthiness of an issuing government. Fiat currency is a legal tender, meaning that fiat currency is accepted as payment for all debts and obligations within the jurisdiction of the issuing government. The value of fiat currency is primarily determined by supply and demand, and it is not pegged to any other commodity or asset.

In the context of the specification, the term “cryptocurrency” refers to a type of digital or virtual currency that uses cryptography for security and operates on decentralized networks based on blockchain technology. Unlike traditional currencies issued by governments and central banks, cryptocurrencies leverage cryptographic techniques to secure transactions, control the creation of new units, and verify the transfer of assets. Key characteristics of cryptocurrencies include decentralization, which means they are typically not controlled by any central authority, and a distributed ledger, or blockchain, that records all transactions across a network of computers. Examples of popular cryptocurrencies include Bitcoin, Ethereum, Ripple, and Litecoin. Cryptocurrencies can be used for various purposes, including online transactions, and investment, and as a means of transferring value across borders without the need for traditional banking systems.

In the context of the specification, the term “financial message” refers to a standardized and structured electronic communication used to convey financial information between financial institutions or other authorized participants in the financial system. These messages are typically used to initiate, process, or complete financial transactions, such as payments, securities transfers, or trade settlements.

In the context of the specification, the term “web server” refers to a computer system or an executable segment of machine-readable code that allows communication with client systems (such as a web browser or a standalone computer application) using the Hypertext Transfer Protocol (HTTP), a set of rules that define how web servers and clients exchange information. When a user types a URL into a web browser (acting as a client), the browser sends an HTTP request to the web server that hosts the website. The web server then processes the request and sends back an HTTP response that contains the requested content.

In the context of the specification, the term “processor” refers to one or more of a microprocessor, a microcontroller, a general-purpose processor, a Field Programmable Gate Array (FPGA), or an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a non-volatile storage memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of the specification, the phrase “communication network” refers to a group of several connected devices including computing devices (such as desktops, mobile handheld devices, tablet PCs, notebooks, etc.), local and remotely located servers (such as web servers, application servers, database servers, Application Program Interface (API) servers, load balancers, compute nodes, and the like), routers, antennas, modems, multiplexers, demultiplexers, and the like. In that regard, the aforementioned connected devices may be able to exchange data signals through wired and/or wireless means as per several combinations of several different communication protocols such as 802.11 (Wi-Fi), 802.3 (Ethernet), Bluetooth, NFC, ZigBee and 3GPP protocols such as HSPA, HSDPA, LTE, GSM, CDMA, WLL and the like.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 illustrates an example environment of devices in which several embodiments of the present invention may be implemented;

FIG. 2 illustrates a computer-implemented method for secure exchange of currency, in accordance with an embodiment of the present invention;

FIG. 3 illustrates a data structure depicting several users and respective public keys assigned to the several users in a public key database, in accordance with an embodiment of the present invention;

FIG. 4 illustrates an example interface providing published information of a currency exchange transaction, in accordance with an embodiment of the present invention; and

FIG. 5 illustrates an example instance of a distributed ledger maintaining a record of several transactions involving exchange of the currency, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention provide computer-implemented methods and computer systems for secure exchange of currency. The currency may be a fiat currency, such as US Dollars, British Pound Sterling, Japanese Yen, or Indian Rupee, etc., or a cryptocurrency such as Bitcoin, Ethereum, Dogecoin, etc. The computer-implemented methods and the computer systems include the use of a pair of correlated keys, where one of the keys is regarded as a public key and another one is regarded as a private key. While the public keys of several users are maintained in a public key database, respective private keys are held by the users and are not shared or transmitted during communication with other devices. The public keys may also be appended with user identification details (such as name, user ID, email address, etc.) belonging to users to whom the respective public keys have been assigned. User identification details and a public key assigned to the user may together constitute a digital certificate awarded to the user by a Certifying Authority (CA). In that regard, a sender wishing to send a predetermined amount of a currency to a receiver obtains a receiver digital certificate assigned to the receiver, from a controller. The receiver digital signature may include a receiver public key assigned to the receiver and receiver identification details. The sender then generates, at a sender device associated with the sender, a financial message indicative of the transfer of the predetermined amount of the currency to a receiver financial account of the receiver. The financial message includes the receiver identification details obtained from the receiver digital certificate. Furthermore, the financial message is transmitted from the sender device to the controller. The public key of the receiver can in some cases be computed from a social account or contacts of the receiver that can be used to compute the public key reative to that account without prior communication with the receiver.

The controller may facilitate the transfer of the predetermined amount of the currency to the receiver financial account. The receiver wanting to withdraw all or a part of the predetermined amount of the currency withdrawn may send a request for withdrawal to the controller, from a receiver device associated with the receiver. The request for withdrawal may include a receiver digital signature generated by encrypting the receiver identification details with a receiver private key assigned to the receiver. The controller may decrypt the receiver digital signature using the receiver public key obtained from the public key database to verify the receiver identification details of the receiver. On successful verification of the receiver, the controller may then facilitate the withdrawal of part of the predetermined amount of the currency by the receiver.

The controller may then publish the sender identification details of the sender, the receiver identification details, and the predetermined amount of the currency transferred to the receiver financial account through a webpage or a notification page. Furthermore, the controller may also generate a transaction hash by hashing together a transaction ID assigned to the currency exchange, the receiver identification details of the receiver, the sender identification details of the sender, the predetermined amount of currency transferred to the receiver financial account associated with the receiver, a random nonce, and a timestamp. The transaction hash may then be added to a distributed ledger being maintained on several nodes, as a new block, for tamper resistance and non-repudiation objectives.

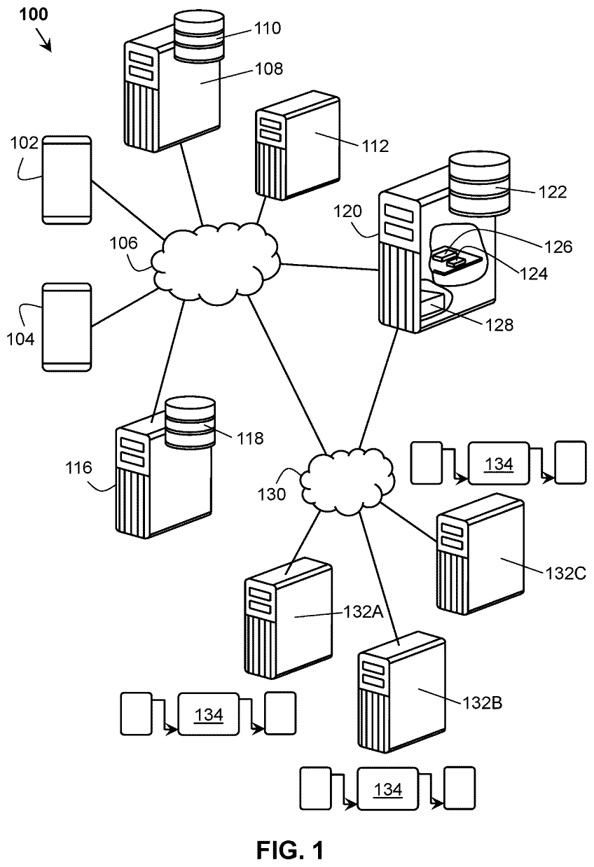

Several embodiments of the present invention will now be explained in detail with the help of FIGS. 1-5.

FIG. 1 illustrates an example environment 100 of devices in which several embodiments of the present invention may be implemented. The environment 100 includes a sender device 102 belonging to or associated with a sender of a currency. Furthermore, the environment 100 includes a receiver device 104 belonging to or associated with a receiver of the currency. Both the sender and the receiver are envisaged to be users of a currency exchange service described as the present invention. In that regard, each user, whether acting as the sender or the receiver would have enrolled with the service and would have been assigned a public and a private key encryption key pair. For the description, the public and the private encryption key pair assigned to the sender would be referred to as a sender public key and a sender private key. Similarly, the public and the private encryption key pair assigned to the receiver would be referred to as a receiver public key and a receiver private key.

Both the sender device 102 and the receiver device 104 may be selected from a group consisting of mobile handheld devices such as smartphones or Personal Digital Assistants (PDAs), notebook PCs, tablet PCs, desktop PCs, and the like. The sender device 102 and the receiver device 104 are further configured to securely store the sender private key and the receiver private key, respectively. The security of keys may be ensured through software-based encryption and access control, Hardware Security Modules (HSMs) provided with PIN authentication and self-destruction mechanisms, Trusted Platform Modules (TPMs) in the form of embedded chips, secure enclaves as isolated areas in processors for storing encryption keys and other sensitive information.

The sender device 102 and the receiver device 104 are connected to a first communication network 106. Further connected to the first communication network 106 is a sender financial institution server 108 and a corresponding sender financial institution database 110 associated with a financial institution with which the sender might hold one or more financial accounts. The financial institution in that regard may be a privately and/or publicly owned bank, a credit union, a non-banking funds corporation, and the like. The sender financial institution server 108 may maintain financial information about the sender, such as account number, type of account, credit history, account balance, credit or debit card accounts issued, available payment channels, and the like. Further connected to the first communication network 106 is a receiver financial institution server 116 and a corresponding receiver financial institution database 118 associated with a financial institution with which the receiver might hold one or more financial accounts. The receiver financial institution database 118 may maintain financial information about the receiver, such as account number, type of account, credit history, account balance, credit or debit card accounts issued, available payment channels, and the like.

Further connected to the first communication network 106 is a web server 112. The web server 112 is envisaged to be configured to generate webpages in several different formats such as Hypertext Markup Language (HTML), Cascading Style Sheets (CSS), JavaScript, Hypertext Preprocessor (PHP), Extensible Markup Language (XML), Python, and Java. Furthermore, a controller 120 is connected to the first communication network 106. The controller 120 is envisaged to include capabilities of several different forms of servers such as an application server, a database server, a gateway server, a load balancer, and the like. The controller 120 is further envisaged to be enabled with computing capabilities through a processor 124, a memory unit 126 configured to store machine-readable instructions at least temporarily, and a communication interface 128. The controller 120 is further connected to a storage device 122 configured to store machine-readable instructions, user databases, communication protocols, IP addresses of the other devices of the environment 100, and the like.

The controller 120 is also connected to a second communication network 130. The second communication network 130 enables communication between several compute nodes 132A, 132B, and 132C to maintain a distributed ledger 134. It is further envisaged, that each one of the several compute nodes 132A, 132B, and 132C maintains an identical copy of the distributed ledger 134 (also referred to as “the blockchain 134”). Further, it is also envisaged that the first communication network 106 can communicate with the second communication network 130. Several embodiments of the present invention will now be elucidated with the help of the environment 100 taken as a reference. However, a person skilled in the art would appreciate that the embodiments of the invention discussed in the following discussion may also be implemented through several other alternative constructions of the environment 100, without departing from the scope of the invention.

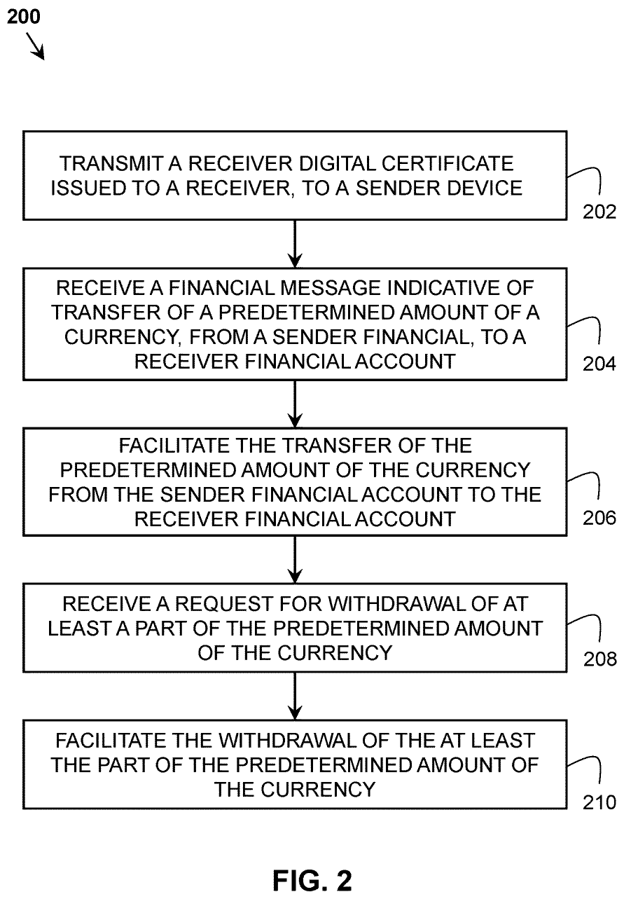

FIG. 2 illustrates a computer-implemented method 200 for the secure exchange of currency, in accordance with an embodiment of the present invention. The computer-implemented method 200 is envisaged to be performed by the processor 124 executing machine-readable instructions stored in the memory unit 126. The computer-implemented method 200 begins at Step 202.

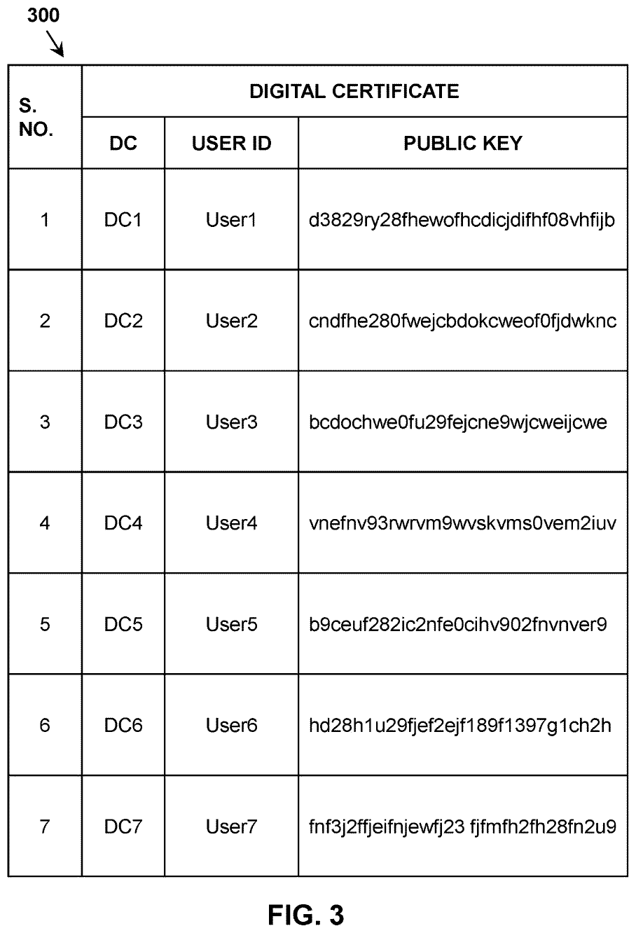

At Step 202, the processor 124 transmits a receiver digital certificate DC5 issued to the receiver device, to the sender device 102. The receiver digital certificate includes a receiver public key assigned to the receiver and receiver identification details belonging to the receiver. In that regard, digital certificates of all the users may be maintained in a public key database 300 illustrated in FIG. 3.

The public key database 300 maintains a list of respective digital certificates assigned to enlisted users of the service provided by the means of the present invention. Furthermore, each digital certificate at least includes user identification details USER ID and a respective public key PUBLIC KEY. For example, the sender may be assigned sender identification details as User1 included in a sender digital certificate DC1, and the receiver may be assigned receiver identification details as User5 included in a receiver digital certificate DC5. The request received from the sender device 102 may include sender identification details User1 and may be encrypted with the sender private key. The controller 120 may further decrypt the encrypted request using the sender public key accessed from the public key database 300 to verify the identity of the sender.

Here again, the receiver digital certificate DC5 transmitted to the sender device 102 may be encrypted with the sender public key for secured communication. The sender device 102, on receiving the encrypted message from the controller 120, may decrypt the message using the sender private key to obtain the receiver digital certificate DC5. Furthermore, the sender device 102 may then extract the receiver identification details User5 from the receiver digital certificate DC5. Further, a financial message, indicative of the transfer of a predetermined amount of a currency from a sender financial account of the sender to a receiver financial account of the receiver, is generated at the sender device 102.

The public key of the receiver can be computed from a social account or contacts of the receiver that can be used to compute the public key relative to that account without prior communication with the receiver.

The sender financial institution server 108 may maintain the sender financial account and the receiver financial account may be maintained by the receiver financial institution server 116. In several alternate embodiments of the invention, the sender financial account and the receiver financial account may both be maintained by any one of the sender financial institution server 108, the receiver financial institution server 116, and the controller 120. The currency may be selected from a group consisting of fiat currencies and cryptocurrencies. Also, the receiver identification details User5 are added to the financial message at the sender device 102. Furthermore, in several embodiments of the invention, the financial message may be encrypted with the sender private key for secure transmission of the financial message. In several alternate embodiments, the communications between the controller 120 and the sender device 102 may be encrypted using a session key generated after an initial security handshake as per Secure Service Layer (SSL) architecture.

At Step 204, the processor 124 receives the financial message from the sender device 102 and decrypts the financial message using the sender public key or the session key, as applicable, to obtain a value of the predetermined amount of the currency and the receiver identification details User5. Furthermore, the processor 124 verifies the identity of the receiver using the obtained receiver identification details User5.

At Step 206, the processor 124 facilitates the transfer of the predetermined amount of the currency from the sender financial account to the receiver financial account. In that regard, the processor 124 may provide a secure communication channel between the sender financial institution server 108 and the receiver financial institution server 116 for exchanging financial messages. As a result, the predetermined amount of the currency is debited from the sender financial account after verification of the minimum balance in the sender financial account. Other verification such as protocol of financial message, credit score of the sender and/or the receiver, and security level of communication channels may also be performed before the transfer of the predetermined amount of the currency to the receiver financial account. Furthermore, the receiver financial account is credited with the predetermined amount of the currency. In several embodiments of the invention, the processor 124 may further notify the receiver about the credit of the predetermined amount of the currency into the receiver financial account through a push notification, an SMS, an email, and/or an instant message at the receiver device 104.

At Step 208, the processor 124 receives a request for withdrawal of all or a part of the predetermined amount of the currency, from the receiver device 104. In that regard, the request for withdrawal will include a receiver digital signature associated with the receiver. The receiver digital signature may be created by encrypted receiver identification details User5 with receiver private key at the receiver device 104. The processor 124 may then decrypt the receiver digital signature using the receiver public key obtained from the public key database 300, to verify the identity of the receiver. Therefore, the receiver digital signature may act as a cryptographic proof of the identity of the receiver.

At Step 210, on successful verification of the receiver, the processor 124 would then facilitate the withdrawal of the all or the part of the predetermined amount of the currency from the receiver financial account. The receiver may use the withdrawn part of the predetermined amount as cash or for making purchases of goods and/or services. Furthermore, in several embodiments of the invention, the controller 120 may publish transaction information through the web server 112. The transaction information in that regard may include the sender identification details User1, the receiver identification details User5, the predetermined amount of the currency transferred from the sender financial account to the receiver financial account, and the part of the predetermined amount of the currency withdrawn by the receiver from the receiver financial account.

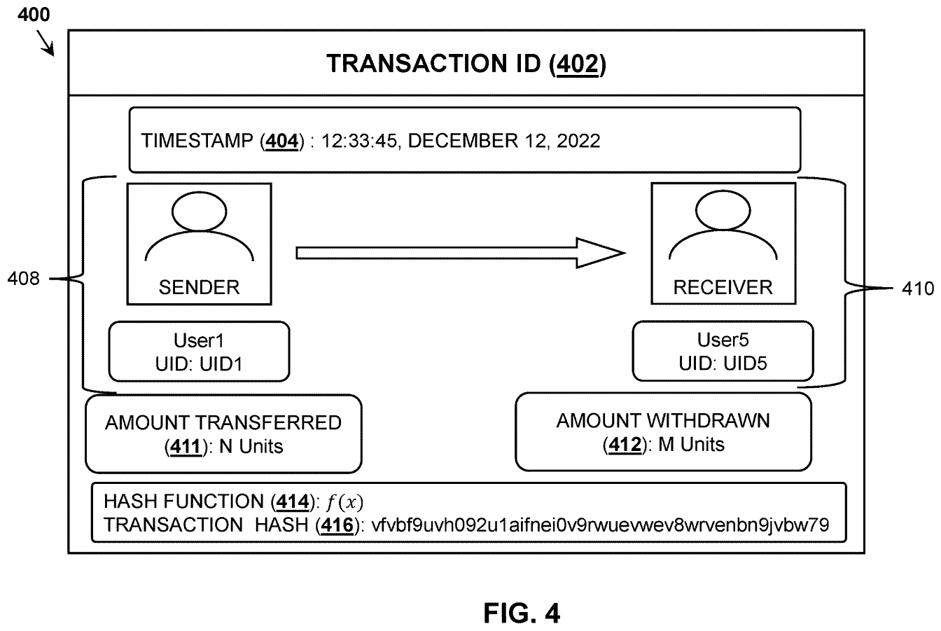

FIG. 4 illustrates an example interface 400 providing published information of a currency exchange transaction, in accordance with an embodiment of the present invention. The example interface 400 depicts a transaction ID 402, a timestamp 404 assigned to the transaction, the sender identification details 408 (User1), the receiver identification details 410 (User5), the predetermined amount of the currency 411 (N units) transferred from the sender financial account to the receiver financial account, and the at least the part 412 (M units) of the predetermined amount of the currency 411 (N units) withdrawn by the receiver. It is to be noted here that only the details of the transaction are published to maintain transparency while other details, such as bank account numbers, actual total balances, credit histories, etc. of the sender and the receiver are kept secret to ensure sufficient confidentiality and privacy. In this manner, the invention provides a useful balance between transparency and confidentiality (or privacy).

Furthermore, in several embodiments of the invention, the processor 124 hashes the transaction information using a hash function 414 to generate a transaction hash 416. The transaction information may include the sender identification details 408 (User1), the receiver identification details 410 (User5), the predetermined amount of the currency 411 (N units) transferred from the sender financial account to the receiver financial account, and optionally, the part 412 (M units) of the predetermined amount of the currency 411 (N units), withdrawn by the receiver. Furthermore, in several embodiments, the controller 120 may also add the timestamp 404 to the transaction information before generating the transaction hash 416. Furthermore, the processor 124 may then add the transaction hash 416 to the distributed ledger 134 to add a new block to the distributed ledger.

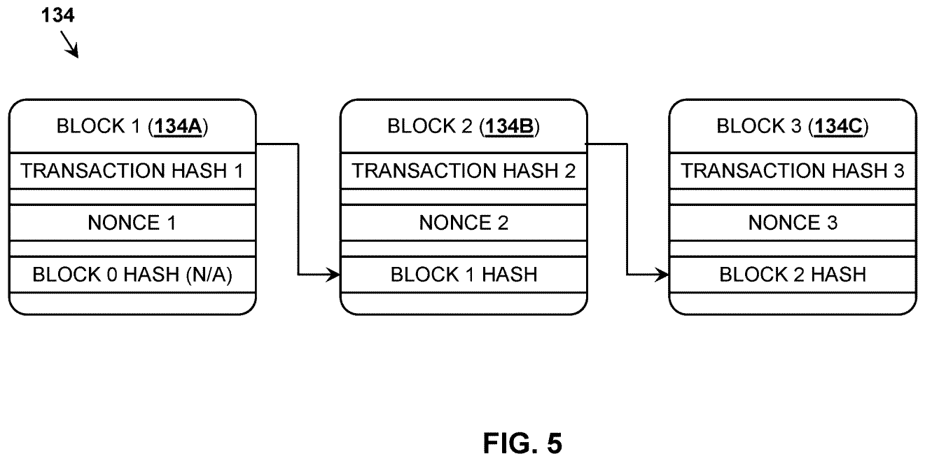

FIG. 5 illustrates an example instance of the distributed ledger 134 maintaining a record of several transactions involving exchange of the currency, in accordance with an embodiment of the present invention. The distributed ledger 134 may include a plurality of blocks 134A, 134B, and 134C. Each block (for example, 134B) of the distributed ledger 134 includes a transaction hash of a corresponding transaction represented by the block, a random nonce, and a hash of a previous block. Therefore, as more and more blocks are added to the distributed ledger 134, the distributed ledger 134 becomes increasingly tamper-resistant and non-repudiable. Moreover, identical copies of the distributed ledger 134 are maintained at each one of the several compute nodes 132A, 132B, and 132C to ensure that even if one copy is successfully tampered with, the presence of other copies will be able to isolate the tampered copy.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention.

1. A computer implemented method for secure exchange of currency, the computer implemented method comprising:
transmitting, by a controller, a receiver digital certificate issued to a receiver, to a sender device associated with a sender, wherein the receiver digital certificate comprises a receiver public key assigned to the receiver and receiver identification details belonging to the receiver;
receiving, by the controller, a financial message indicative of transfer of a predetermined amount of a currency, from a sender financial account assigned to the sender, to a receiver financial account assigned to the receiver, wherein the financial message comprises the receiver identification details;
facilitating, by the controller, transfer of the predetermined amount of the currency from the sender financial account to the receiver financial account;
receiving, by the controller, a request for withdrawal of all or a part of the predetermined amount of the currency, from a receiver device associated with the receiver, the request for withdrawal comprising a receiver digital signature associated with the receiver; and
facilitating, by the controller, the withdrawal of the all or the part of the predetermined amount of the currency from the receiver financial account.

2. The computer implemented method as claimed in claim 1, further comprising publishing transaction information comprising sender identification details associated with the sender, the receiver identification details, and the all or the part of the predetermined amount of currency withdrawn from the receiver financial account.

3. The computer implemented method as claimed in claim 1, wherein the currency is selected from a group comprising fiat currencies and cryptocurrencies.

4. The computer implemented method as claimed in claim 1, further comprising:
hashing transaction information comprising sender identification details associated with the sender, the receiver identification details, and the predetermined amount of currency transferred to the receiver financial account, to generate a transaction hash, and
adding the transaction hash to a distributed ledger.

5. The computer implemented method as claimed in claim 4, further comprising adding a time stamp to the transaction information before generating the transaction hash.

6. A computer system for secure exchange of currency, the computer system comprising:
a controller, the controller comprising:
a memory unit comprising machine-readable instructions,
a processor operably connected to the memory unit, the processor configured to execute machine-readable instructions, the machine-readable instructions when executed by the processor, enable the processor to:
transmit a receiver digital certificate issued to a receiver, to a sender device associated with a sender, wherein the receiver digital certificate comprises a receiver public key assigned to the receiver and receiver identification details belonging to the receiver,
receive a financial message indicative of transfer of a predetermined amount of a currency, from a sender financial account assigned to the sender, to a receiver financial account assigned to the receiver, wherein the financial message comprises the receiver identification details,
facilitate transfer of the predetermined amount of the currency from the sender financial account to the receiver financial account,
receive a request for withdrawal of all or a part of the predetermined amount of the currency, from a receiver device associated with the receiver, the request for withdrawal comprising a receiver digital signature associated with the receiver, and
facilitate the withdrawal of the all or the part of the predetermined amount of the currency from the receiver financial account.

7. The computer system as claimed in claim 6, wherein the processor is further enabled to publish transaction information comprising sender identification details associated with the sender, the receiver identification details, and the predetermined amount of currency transferred to the receiver financial account.

8. The computer system as claimed in claim 6, wherein the currency is selected from a group comprising fiat currencies and cryptocurrencies.

9. The computer system as claimed in claim 6, wherein the processor is further enabled to:
a hash transaction information comprising sender identification details associated with the sender, the receiver identification details, and the all or the part of the predetermined amount of currency transferred to the receiver financial account, to generate a transaction hash, and
add the transaction hash to a distributed ledger.

10. The computer system as claimed in claim 9, wherein the processor is further enabled to add a time stamp to the hash transaction information before generating the transaction hash.
